(19) United States
(12) Patent Application Publication
(10) Pub. No.: US 2025/0223132 A1
(43) Pub. Date: Jul. 10, 2025

(54) ELEVATOR SYSTEM CONFIGURED TO PROVIDE CAR TONE BASED ON USER FEEDBACK

(71) Applicant: OTIS ELEVATOR COMPANY, Farmington, CT (US)

(72) Inventor: Peter DePaola, Glastonbury, CT (US)

(21) Appl. No.: 18/404,240

(22) Filed: Jan. 4, 2024

(51) Int. Cl. B66B 3/00

(52) U.S. Cl. CPC B66B 3/002; B66B 2201/104; B66B 2201/4653

(57) ABSTRACT

An elevator system having: an elevator car having a door opening; a controller configured to control the elevator car; and a car call implement configured transmit a first request to the controller to instruct the elevator car to travel to a lobby to pickup a user, wherein the first request includes an arrival chime code indicative of an arrival chime, selected from a plurality of the arrival chimes, audibly played by a speaker proximate to the car door opening when the elevator car arrives at the landing.

### BACKGROUND

The application is directed to elevator systems and more specifically to an elevator system configured to provide a car tone based on user feedback.

For an elevator passenger with a disability, being able to identify their car as it arrives at the landing can be a challenge. Particularly for destination dispatch systems where the passenger is assigned a specific car, it is desirous for the passenger to locate and enter the appropriate assigned car.

### BRIEF SUMMARY

Disclosed is an elevator system including: an elevator car having a door opening; a controller configured to control the elevator car; and a car call implement configured transmit a first request to the controller to instruct the elevator car to travel to a lobby to pickup a user, wherein the first request includes an arrival chime code indicative of an arrival chime, selected from a plurality of the arrival chimes, audibly played by a speaker proximate to the car door opening when the elevator car arrives and/or is departing a floor landing.

In addition to one or more aspects of the elevator system or as an alternate, the arrival chime is selected by one of the user, the car call implement or the controller.

In addition to one or more aspects of the elevator system or as an alternate, the car call implement is a call panel or a smartphone or a smartwatch.

In addition to one or more aspects of the elevator system or as an alternate, the arrival chime code that is within the first request is generated in response to user input received by the car call implement, wherein the user input is indicative of a user condition or a user preference.

In addition to one or more aspects of the elevator system or as an alternate, the arrival chime code is indicative of a disability of the user.

In addition to one or more aspects of the elevator system or as an alternate, each of the plurality of the arrival chimes has a sound characteristic that is different from each other of the plurality of the arrival chimes.

In addition to one or more aspects of the elevator system or as an alternate, the car call implement selects the arrival chime code upon receiving the first request from the user.

In addition to one or more aspects of the elevator system or as an alternate, the controller selects the arrival chime code upon receiving the first request from the car call implement.

In addition to one or more aspects of the elevator system or as an alternate, the car call implement receives, from the user, input indicative of a selection of the arrival chime code when generating the first request.

In addition to one or more aspects of the elevator system or as an alternate, the system includes a speaker near the car call implement in addition to the car door opening, wherein the car call implement is configured to play the arrival chime proximate to when the arrival chime is selected and when the elevator car arrives at the landing from the speaker near the car door opening.

Further disclosed is a method of operating an elevator system including: receiving, by a car call implement, a first request to instruct an elevator car to travel to a floor to pickup a user; and transmitting, by the car call implement, the first request to a controller, wherein the first request includes an arrival chime code indicative of an arrival chime, selected from a plurality of the arrival chimes, that is audibly played by a speaker proximate to a car door opening of the elevator car when the elevator car arrives at the lobby.

In addition to one or more aspects of the method or as an alternate, the method includes selecting the arrival chime by one of the user, the car call implement or the controller.

In addition to one or more aspects of the method or as an alternate, the car call implement is a call panel or a smartphone or smart device.

In addition to one or more aspects of the method or as an alternate, the method includes generating the arrival chime code that is within the first request in response to receiving user input by the car call implement, wherein the user input is indicative of a user condition or a user preference.

In addition to one or more aspects of the method or as an alternate, the arrival chime code is indicative of a disability of the user.

In addition to one or more aspects of the method or as an alternate, each of the plurality of the arrival chimes has a sound characteristic that is different from each other of the plurality of the arrival chimes.

In addition to one or more aspects of the method or as an alternate, the method includes selecting the arrival chime code by the car call implement upon receiving the first request from the user.

In addition to one or more aspects of the method or as an alternate, the method includes selecting the arrival chime code by the controller upon receiving the first request from the car call implement.

In addition to one or more aspects of the method or as an alternate, the method includes receiving, by the car call implement from the user, input indicative of a selection of the arrival chime code when generating the first request.

In addition to one or more aspects of the method or as an alternate, the method includes playing, by the car call implement, a sample of the arrival chime proximate to when the arrival chime is selected and playing the arrival chime from the speaker proximate to the car door opening when the elevator car arrives at the landing.

### BRIEF DESCRIPTION OF THE DRAWINGS

The present disclosure is illustrated by way of example and not limited in the accompanying figures in which like reference numerals indicate similar elements.

FIG. 1 is a schematic illustration of an elevator system that may employ various embodiments of the present disclosure;

FIG. 2 shows aspects of an elevator system configured to provide car tone based on user feedback; and

FIG. 3 is a flowchart showing a method of operating an elevator system to provide car tone based on user feedback.

### DETAILED DESCRIPTION

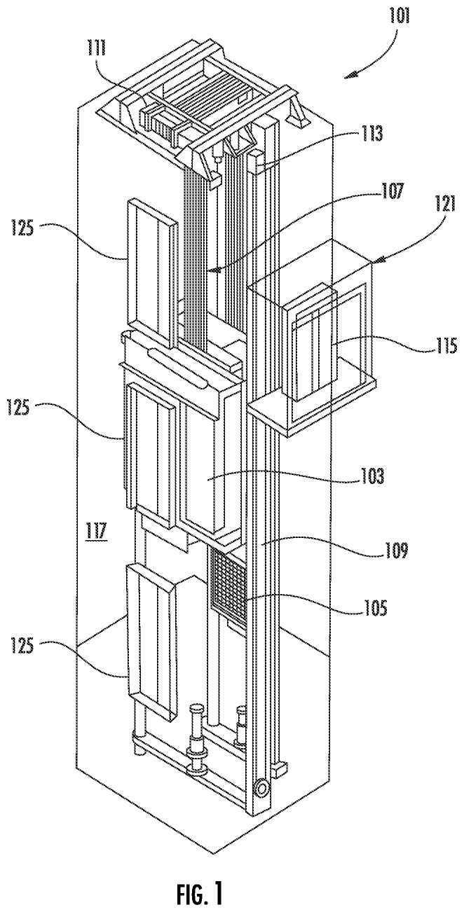

FIG. 1 is a perspective view of an elevator system 101 including an elevator car 103, a counterweight 105, a tension member 107, a guide rail (or rail system) 109, a machine (or machine system) 111, a position reference system 113, and an electronic elevator controller (controller) 115. The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft (or hoistway) 117 and along the guide rail 109.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the elevator shaft 117, such as on a support or guide rail, and may be configured to provide position signals related to a position of the elevator car 103 within the elevator shaft 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counter weight, as known in the art. For example, without limitation, the position reference system 113 can be an encoder, sensor, or other system and can include velocity sensing, absolute position sensing, etc., as will be appreciated by those of skill in the art.

The controller 115 may be located in a controller room 121 of the elevator shaft 117. It is to be appreciated that the controller 115 need not be in the controller room 121 but may be in the hoistway or other location in the elevator system. According to an aspect, the controller 115 is configured to control the operation of the elevator system 101, and particularly the elevator car 103. For example, the controller 115 may provide drive signals to the machine 111 to control the acceleration, deceleration, leveling, stopping, etc. of the elevator car 103. The controller 115 may also be configured to receive position signals from the position reference system 113 or any other desired position reference device. When moving up or down within the elevator shaft 117 along guide rail 109, the elevator car 103 may stop at one or more landings 125 as controlled by the controller 115. Although shown in an controller room 121, those of skill in the art will appreciate that the controller 115 can be located and/or configured in other locations or positions within the elevator system 101. In one embodiment, the controller may be located remotely or in the cloud.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within elevator shaft 117.

Although shown and described with a roping system including tension member 107, elevator systems that employ other methods and mechanisms of moving an elevator car within an elevator shaft may employ embodiments of the present disclosure. For example, embodiments may be employed in ropeless elevator systems using a linear motor to impart motion to an elevator car. Embodiments may also be employed in ropeless elevator systems using a hydraulic lift to impart motion to an elevator car. Embodiments may also be employed in ropeless elevator systems using self-propelled elevator cars (e.g., elevator cars equipped with friction wheels, pinch wheels or traction wheels). FIG. 1 is merely a non-limiting example presented for illustrative and explanatory purposes.

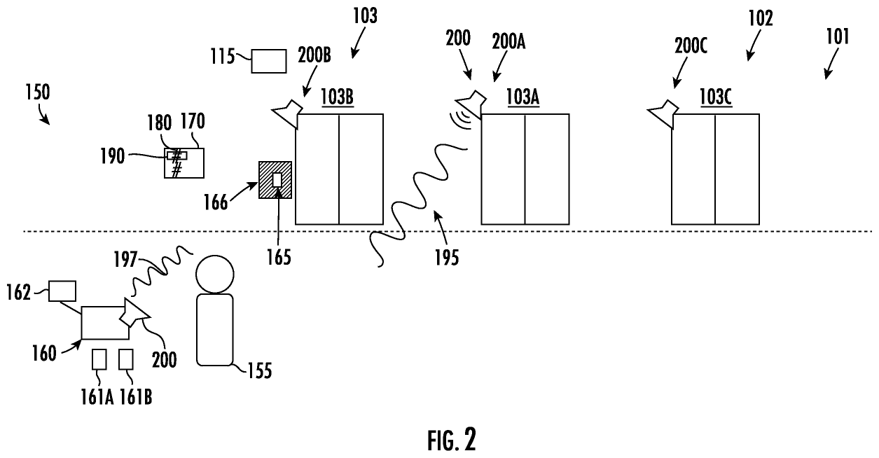

Turning to FIG. 2 and as discussed in greater detail below, the embodiments are directed to the utilization of distinguishable sounds as a car approaches the landing so the passenger can identify the correct car. As the car approaches the landing, a standard chime can be replaced with a distinguishing audio feature so the passenger can identify their intended car. Where local operational code allows, the audio could be different pitches, for example. Where code specifies a specific pitch, the audio could use different sound filters, e.g., plano, bells, chimes, etc., so the frequency meets code, and the sound style can be distinguishable.

As shown in FIG. 2, the elevator system 101 includes an elevator bank 102 with a plurality of elevator cars 103 configured to stop at a lobby (or landing) 150, including first through third cars 103A-103C. It is to be appreciated that the illustration of three cars 103A-103C in FIG. 2 is non-limiting as the embodiments may be implemented in a system 101 having any number of elevator cars 103. A controller 115 is configured to control the elevator cars 103. A car call implement 160 is configured transmit a first request 170 to the controller 115 to instruct the first elevator car 103A to travel to the lobby 150 based on request of a passenger (alternatively referred to as a user) 155.

The first request 170 includes a data field 180 that defines arrival chime code 190 indicative of an arrival chime (or car tone) 195 selected from a plurality of the arrival chimes that can be audibly played via a speaker 200 at the lobby 150 when the first elevator car 103A arrives at the lobby 150. As shown in FIG. 2, each of the cars 103A-130C has a respective speaker 200A, 200B, 200C. Further, a speaker 200D is located at the car call implement 160 to play the tone during the selection as well as the speaker at the car door opening.

The arrival chime 195 is selected by one of the user 155, the car call implement 160 and/or the controller 115. The car call implement 160 can be call panel 161A, fixed in the lobby 150 or a smartphone 161B or smartwatch of the user 155. The call panel 161A may communicate with the controller 115 wirelessly or via wired communication protocols. The smartphone 161b may communicate with the controller 115 utilizing wireless communication protocols.

The arrival chime code 190 that is within the first request 170 is generated in response to user input (or feedback) received by the car call implement 160. The user input is indicative of a user condition or a user preference. For example, the arrival chime code 190 is indicative of a disability of the user 155. In one embodiment, a button 165 is located on a fixture 166 to indicate elevator accessibility, or a setting in the mobile application on the smartphone 161B.

Each of the plurality of the arrival chimes has a sound characteristic that is different from each other of the plurality of arrival chimes. For example, the pitch may be different or a filter may be utilized to keep the pitch and provide a different sound, such as produced by different musical instruments.

In one embodiment, the car call implement 160 selects the arrival chime code 190 upon receiving the first request 170 from the user 155. In one embodiment, the controller 115 selects the arrival chime code 190 upon receiving the first request 170 from the car call implement 160. In one embodiment, the car call implement 160 receives, from the user 155, input indicative of the selection of the arrival chime code 190 when generating the first request 170.

The car call implement 160 may play a sample 197 of the arrival chime 195 proximate to when the arrival chime 195 is selected and elevator speaker 200A will play the arrival chime 195, e.g. the full chime, when the first elevator car arrives 103A at the lobby 150.

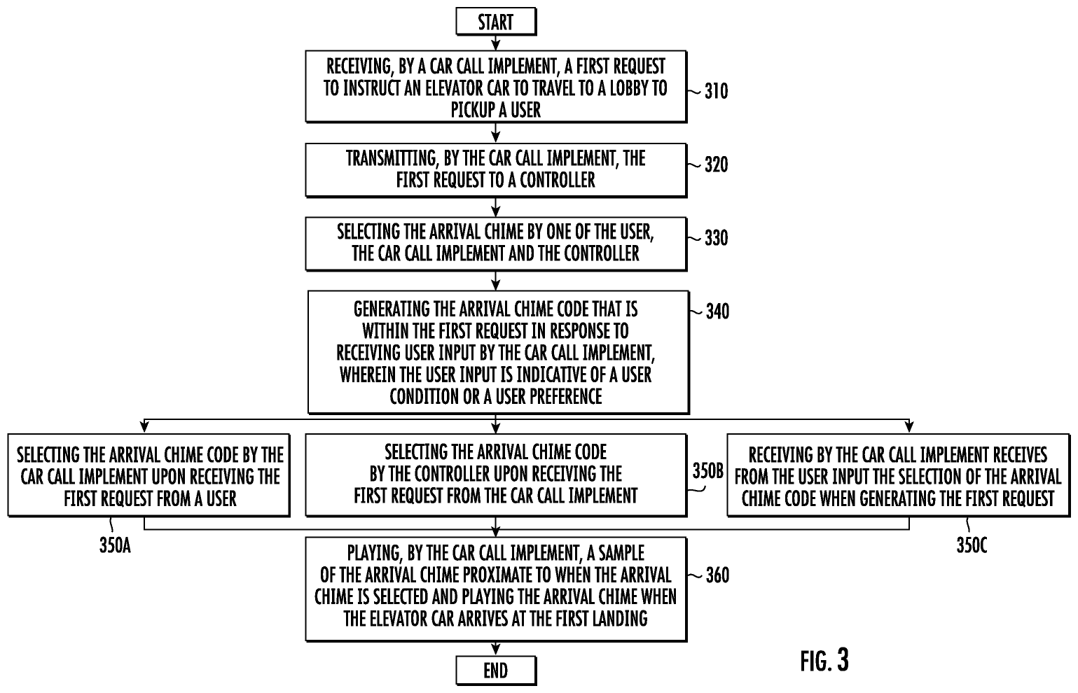

Turning to FIG. 3, a method of operating the elevator system 101 is disclosed. As shown in block 310 the method includes receiving, by the car call implement 160, the first request 170 to instruct the first elevator car 103A to travel to the lobby 150 to pickup a user 155. As shown in block 320 the method includes transmitting, by the car call implement 160, the first request 170 to the controller 115. As indicated above, the first request 170 includes a data field 180 that includes the arrival chime code 190 indicative of the selected arrival chime 195, from the plurality of the arrival chimes, that is audibly played when the first elevator car 103A arrives at the lobby 150.

As shown in block 330 the method includes selecting the arrival chime 195 by one of the user 155, the car call implement 160 or the controller 115. As indicated the car call implement 160 is a call panel 161A or a smartphone 161B. In one embodiment, the selection of the chime sound is performed by the controller or is preset so car 103A is always identified by a certain tone, and car 103B is always identified by a certain different tone, etc.

As shown in block 340 the method includes generating the arrival chime code 190 that is within the first request 170 in response to receiving user input by the car call implement 160. As indicated the user input is indicative of a user condition or a user preference. In one embodiment the arrival chime code 190 is indicative of a disability of the user 155. In one embodiment each of the plurality of the arrival chimes has a sound characteristic that is different from each other of the plurality of arrival chimes.

In one embodiment, as shown in block 350A the method includes selecting the arrival chime code 190 by the car call implement 160 upon receiving the first request 170 from the user 155. In one embodiment, as shown in block 350B the method includes selecting the arrival chime code 190 by the controller 115 upon receiving the first request 170 from the car call implement 160. In one embodiment, as shown in block 350C the method includes receiving, by the car call implement 160 from the user 155, input indicative of the selection of the arrival chime code 190 when generating the first request.

As shown in block 360 the method includes playing, by the car call implement 160, a sample 197 of the arrival chime 195 proximate to when the arrival chime 195 is selected and speaker 200A playing the arrival chime 195 when the first elevator car 103A arrives, or when elevator doors open, at the lobby 150.

Sensor data identified herein may be obtained and processed separately, or simultaneously and stitched together, or a combination thereof, and may be processed in a raw or complied form. The sensor data may be processed on the sensor (e.g. via edge computing), by controllers identified or implicated herein, on a cloud service, or by a combination of one or more of these computing systems. The senor may communicate the data via wired or wireless transmission lines, applying one or more protocols as indicated below.

Wireless connections may apply protocols that include local area network (LAN, or WLAN for wireless LAN) protocols. LAN protocols include WiFi technology, based on the Section 802.11 standards from the Institute of Electrical and Electronics Engineers (IEEE). Other applicable protocols include Low Power WAN (LPWAN), which is a wireless wide area network (WAN) designed to allow long-range communications at a low bit rates, to enable end devices to operate for extended periods of time (years) using battery power. Long Range WAN (LoRaWAN) is one type of LPWAN maintained by the LoRa Alliance, and is a media access control (MAC) layer protocol for transferring management and application messages between a network server and application server, respectively. LAN and WAN protocols may be generally considered TCP/IP protocols (transmission control protocol/Internet protocol), used to govern the connection of computer systems to the Internet. Wireless connections may also apply protocols that include private area network (PAN) protocols. PAN protocols include, for example, Bluetooth Low Energy (BTLE), which is a wireless technology standard designed and marketed by the Bluetooth Special Interest Group (SIG) for exchanging data over short distances using short-wavelength radio waves. PAN protocols also include Zigbee, a technology based on Section 802.15.4 protocols from the IEEE, representing a suite of high-level communication protocols used to create personal area networks with small, low-power digital radios for low-power low-bandwidth needs. Such protocols also include Z-Wave, which is a wireless communications protocol supported by the Z-Wave Alliance that uses a mesh network, applying low-energy radio waves to communicate between devices such as appliances, allowing for wireless control of the same.

Wireless connections may also include radio-frequency identification (RFID) technology, used for communicating with an integrated chip (IC), e.g., on an RFID smartcard. In addition, Sub-1 Ghz RF equipment operates in the ISM (industrial, scientific and medical) spectrum bands below Sub 1 Ghz-typically in the 769-935 MHz, 315 Mhz and the 468 Mhz frequency range. This spectrum band below 1 Ghz is particularly useful for RF IoT (internet of things) applications. The Internet of things (IoT) describes the network of physical objects—“things”—that are embedded with sensors, software, and other technologies for the purpose of connecting and exchanging data with other devices and systems over the Internet. Other LPWAN-IoT technologies include narrowband internet of things (NB-IoT) and Category M1 internet of things (Cat M1-IoT). Wireless communications for the disclosed systems may include cellular, e.g. 2G/3G/4G (etc.). Other wireless platforms based on RFID technologies include Near-Field-Communication (NFC), which is a set of communication protocols for low-speed communications, e.g., to exchange date between electronic devices over a short distance. NFC standards are defined by the ISO/IEC (defined below), the NFC Forum and the GSMA (Global System for Mobile Communications) group. The above is not intended on limiting the scope of applicable wireless technologies.

Wired connections may include connections (cables/interfaces) under RS (recommended standard)-422, also known as the TIA/EIA-422, which is a technical standard supported by the Telecommunications Industry Association (TIA) and which originated by the Electronic Industries Alliance (EIA) that specifies electrical characteristics of a digital signaling circuit. Wired connections may also include (cables/interfaces) under the RS-232 standard for serial communication transmission of data, which formally defines signals connecting between a DTE (data terminal equipment) such as a computer terminal, and a DCE (data circuit-terminating equipment or data communication equipment), such as a modem. Wired connections may also include connections (cables/interfaces) under the Modbus serial communications protocol, managed by the Modbus Organization. Modbus is a master/slave protocol designed for use with its programmable logic controllers (PLCs) and which is a commonly available means of connecting industrial electronic devices. Wireless connections may also include connectors (cables/interfaces) under the PROFibus (Process Field Bus) standard managed by PROFIBUS & PROFINET International (PI). PROFibus which is a standard for fieldbus communication in automation technology, openly published as part of IEC (International Electrotechnical Commission) 61158. Wired communications may also be over a Controller Area Network (CAN) bus. A CAN is a vehicle bus standard that allow microcontrollers and devices to communicate with each other in applications without a host computer. CAN is a message-based protocol released by the International Organization for Standards (ISO). The above is not intended on limiting the scope of applicable wired technologies.

When data is transmitted over a network between end processors as identified herein, the data may be transmitted in raw form or may be processed in whole or part at any one of the end processors or an intermediate processor, e.g., at a cloud service (e.g. where at least a portion of the transmission path is wireless) or other processor. The data may be parsed at any one of the processors, partially or completely processed or complied, and may then be stitched together or maintained as separate packets of information. Each processor or controller identified herein may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory identified herein may be but is not limited to a random access memory (RAM), read only memory (ROM), or other electronic, optical, magnetic or any other computer readable medium.

The controller may further include, in addition to a processor and non-volatile memory, one or more input and/or output (I/O) device interface(s) that are communicatively coupled via an onboard (local) interface to communicate among other devices. The onboard interface may include, for example but not limited to, an onboard system bus, including a control bus (for inter-device communications), an address bus (for physical addressing) and a data bus (for transferring data). That is, the system bus may enable the electronic communications between the processor, memory and I/O connections. The I/O connections may also include wired connections and/or wireless connections identified herein. The onboard interface may have additional elements, which are omitted for simplicity, such as controllers, buffers (caches), drivers, repeaters, and receivers to enable electronic communications. The memory may execute programs, access data, or lookup charts, or a combination of each, in furtherance of its processing, all of which may be stored in advance or received during execution of its processes by other computing devices, e.g., via a cloud service or other network connection identified herein with other processors.

Embodiments can be in the form of processor-implemented processes and devices for practicing those processes, such as processor. Embodiments can also be in the form of computer code based modules, e.g., computer program code (e.g., computer program product) containing instructions embodied in tangible media (e.g., non-transitory computer readable medium), such as floppy diskettes, CD ROMs, hard drives, on processor registers as firmware, or any other non-transitory computer readable medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes a device for practicing the exemplary embodiments. When implemented on a general-purpose microprocessor, the computer program code segments configure the microprocessor to create specific logic circuits.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. An elevator system comprising:
an elevator car having a door opening;
a controller configured to control the elevator car; and
a car call implement configured transmit a first request to the controller to instruct the elevator car to travel to a landing to pickup a user,
wherein the first request includes an arrival chime code indicative of an arrival chime, selected from a plurality of the arrival chimes, audibly played by a speaker proximate to the car door opening when the elevator car arrives at the lobby.

2. The system of claim 1, wherein the arrival chime is selected by one of the user, the car call implement or the controller.

3. The system of claim 2, wherein the car call implement is a call panel or a smartphone or a smartwatch.

4. The system of claim 2, wherein the arrival chime code that is within the first request is generated in response to user input received by the car call implement, wherein the user input is indicative of a user condition or a user preference.

5. The system of claim 4, wherein the arrival chime code is indicative of a disability of the user.

6. The system of claim 1, wherein each of the plurality of the arrival chimes has a sound characteristic that is different from each other of the plurality of the arrival chimes.

7. The system of claim 1, wherein the car call implement selects the arrival chime code upon receiving the first request from the user.

8. The system of claim 1, wherein the controller selects the arrival chime code upon receiving the first request from the car call implement.

9. The system of claim 1, wherein the car call implement receives, from the user, input indicative of a selection of the arrival chime code when generating the first request.

10. The system of claim 4, including a speaker near the car door opening, wherein the car call implement is configured to play the sample arrival chime proximate to when the arrival chime is selected and when the elevator car arrives at the landing from the speaker near the car door opening.

11. A method of operating an elevator system comprising:
receiving, by a car call implement, a first request to instruct an elevator car to travel to a landing to pickup a user; and
transmitting, by the car call implement, the first request to a controller, wherein the first request includes an arrival chime code indicative of an arrival chime, selected from a plurality of the arrival chimes, that is audibly played by a speaker proximate to a car door opening of the elevator car when the elevator car arrives at the lobby.

12. The method of claim 11, including selecting the arrival chime by one of the user, the car call implement or the controller.

13. The method of claim 12, wherein the car call implement is a call panel or a smartphone or smart device.

14. The method of claim 12, including generating the arrival chime code that is within the first request in response to receiving user input by the car call implement, wherein the user input is indicative of a user condition or a user preference.

15. The method of claim 14, wherein the arrival chime code is indicative of a disability of the user.

16. The method of claim 11, wherein each of the plurality of the arrival chimes has a sound characteristic that is different from each other of the plurality of the arrival chimes.

17. The method of claim 11, further comprising selecting the arrival chime code by the car call implement upon receiving the first request from the user.

18. The method of claim 11, further comprising selecting the arrival chime code by the controller upon receiving the first request from the car call implement.

19. The method of claim 11, further comprising receiving, by the car call implement from the user, input indicative of a selection of the arrival chime code when generating the first request.

20. The method of claim 11, further including playing, by the car call implement, a sample of the arrival chime proximate to when the arrival chime is selected and playing the arrival chime from the speaker proximate to the car door opening when the elevator car arrives at the landing.
